(19) United States
(12) Patent Application Publication
(10) Pub. No.: US 2013/0151363 A1
(43) Pub. Date: Jun. 13, 2013

(54) RECOGNIZING MISSING OFFERINGS IN A MARKETPLACE

(71) Applicants: Moe Khosravy, Bellevue, WA (US); Christian Liensberger, Bellevue, WA (US); Roger Mall, Sammamish, WA (US)

(72) Inventors: Moe Khosravy, Bellevue, WA (US); Christian Liensberger, Bellevue, WA (US); Roger Mall, Sammamish, WA (US)

(73) Assignee: MICROSOFT CORPORATION, Redmond, WA (US)

(21) Appl. No.: 13/316,577

(22) Filed: Dec. 12, 2011

(51) Int. Cl. G06Q 30/00

(52) U.S. Cl. 705/26.1

(57) ABSTRACT

A data fulfillment system is described herein that identifies data needs of data marketplace consumers and actively seeks out and attempts to fulfill those needs by adding new data and data providers to the marketplace. After a user enters a search, the system captures the search term(s). If no matching data is found, the data fulfillment system presents to the consumer a screen to suggest a new data offering and to provide a description of data for which the consumer was looking. The system then mines these consumer wants to seek partnerships programmatically by seeing who has this data or operates in this space. Thus, the data fulfillment system provides implicit and explicit ways for consumers to provide information describing data offerings that they want and for potential providers to learn about opportunities to fill current data gaps.

### BACKGROUND

Software applications consume a variety of types of input data. With the emergence of Internet-based, always-connected computing, the amount of data available to applications and the types of applications for processing that data have increased enormously. Cloud computing is an emerging trend for distributed processing of and access to data. Data may include information such as zip codes for address verification, translation information for languages, corporate revenue or other statistics for companies, employment information for people, social network connections of people, and any other type of information. Applications are typically custom built either with this data built in, or with some hard-coded well-known access location for acquiring this data at run time. When an application needs new types of data, it is often up to the software developer to search for available sources of that data and to purchase the data on some one-time or subscription basis.

Data markets such as MICROSOFT™ AZURE™ DataMarket are emerging as a common source for finding and purchasing various types of data used by end users or software programs. As more and more users are starting to learn about and using DataMarket and its competitors from cloud computing providers, they are feeding in data that can be used to drive strategic onboarding of content as well as identifying applications that need to be built to leverage this content. For example, someone seeing weather information in the data market may observe that there are few good applications for displaying the weather data. Conversely, an application developer that wants to write a weather application may find that the data the developer needs is not available in the marketplace.

When people search on these up and coming data marketplaces, many times what they are looking for will not be found as the data does not exist or is not yet made publicly available. This may lead to the person looking for an alternative private source of the data or to the person creating a proprietary data store of his own for collecting and using the data. Several people may do this at the same time so that many redundant efforts to collect and store the data exist. Although some may choose to share this data in the data marketplace and potentially profit from their efforts to collect the data, others will keep the data private. Although data marketplace providers know what data people are buying and using, the marketplace in general has no information about data that people wanted but did not find, or data in the marketplace that would be more useful if perhaps placed in a different format or augmented with additional data.

### SUMMARY

A data fulfillment system is described herein that identifies data needs of data marketplace consumers and actively seeks out and attempts to fulfill those needs by adding new data and data providers to the marketplace. In some embodiments, the system captures consumer searches for data. After a user enters a search, the system captures the search term(s). If no matching data is found, the data fulfillment system presents to the consumer a screen to suggest a new data offering and to provide a description of data for which the consumer was looking. The description may also include web services or applications that the consumer was looking for to consume particular data. The system then mines these consumer wants to seek partnerships programmatically by seeing who has this data or operates in this space. The system may also feed this consumer want information to business development teams and content onboarding who are now aware that there is a real opportunity for providing particular data or applications based on demand. Thus, the data fulfillment system provides implicit and explicit ways for consumers to provide information describing data offerings that they want and for potential providers to learn about opportunities to fill current data gaps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the data fulfillment system, in one embodiment.

FIG. 2 is a flow diagram that illustrates processing of the data fulfillment system to handle consumer data queries, in which at least one query results in no matching data, in one embodiment.

FIG. 3 is a flow diagram that illustrates processing of the data fulfillment system to provide information regarding data fulfillment opportunities to a data provider using a data marketplace, in one embodiment.

### DETAILED DESCRIPTION

A data fulfillment system is described herein that identifies data needs of data marketplace consumers and actively seeks out and attempts to fulfill those needs by adding new data and data providers to the marketplace. In some embodiments, the system captures consumer searches for data. After a user enters a search, the system captures the search term(s). If no matching data is found, instead of a “nothing found” response like existing systems, the data fulfillment system presents to the consumer a screen to suggest a new data offering and to provide a description of data for which the consumer was looking. The data may also include web services or applications that the consumer was looking for to consume particular data. The system then mines these consumer wants to seek partnerships programmatically by seeing who has this data or operates in this space. The system may also feed this consumer want information to business development teams and content onboarding (as well as potentially independent software vendors (ISVs)) who are now aware that there is a real opportunity for providing particular data or applications based on demand. This flow and experience allows sales force optimizations for marketplace providers—public and private to drive ecosystems—connecting buyers and sellers of data and data-consuming applications.

The data fulfillment system provides a user experience (UX) for allowing a user to suggest a data offering if nothing is found. The user is able to provide detailed information about the data for which the user was searching. The system automatically classifies the search as a type of application or dataset based on semantics and well-known classification techniques (e.g., a search for “fuel prices” will result in a category addition of navigation, transportation, and oil and gas) using related service lookups as well as name matching, pattern matching, and allowing a user to suggest other categories of data. In some embodiments, the system automatically shows the user potential datasets that are not in the marketplace yet and asks the user which one the user would purchase if the datasets were available. On the backend, the system uses user want data to create lead generation for a marketplace team and partners (who can soon operate their own private marketplaces, using this as a big differentiator for what content they gather and expose to their customers). The system can also provide lead scoring of opportunities at play against the continuous backlog of searches performed by users. For example, if the business development and content teams have providers from navigation, crime, and weather data in a customer relationship management (CRM) solution, the augmentation of this data with a simple score or indicator (red, green, yellow) can be used to help them favor one partner over the other—due to availability of content in the marketplace, pricing currently at play, and so on. Thus, the data fulfillment system provides implicit and explicit ways for consumers to provide information describing data offerings that they want and for potential providers to learn about opportunities to fill current data gaps.

The following paragraphs provide a conceptual view of the data fulfillment system, in one embodiment. The system maintains a supply database for offers in the marketplace as well as a demand database used to capture items searched for but not found (note that while these are conceptually separate databases, they may be hosted by the same database instance). As data is searched for and found a popularity index for the content goes up in the supply database. In addition, users are able to either privately or publically comment on the offerings (data or applications) to provide negative feedback if, for example, pricing is too high, an application is unstable, terms are unacceptable or to provide positive feedback or suggestions like, “would like to enable mobile scenarios as well”. The system automatically gathers sentiment from the notes and feedback to provide an overall view of how the dataset is performing in the marketplace, qualitatively in addition to sales and other quantitative metrics. The system may provide a purchase history for offerings (data, web services, applications, and so on) so consumers can see which datasets are interesting. Users can also provide private or public feedback about categories, such as whether a category is missing data, whether a category is missing, whether a category contains useful data or is useful for their work, and so forth.

As data is used, the data fulfillment system records and aggregates data query patterns in the supply database. The system then analyzes these use patterns to determine which parts of the existing data are the most used. The system also analyzes use patterns to determine which data is used with which other types of data and thereby to determine which new offerings would be useful if created.

As data is searched and not found, the system records such queries and terms in the demand database. The system records context information about the search, such as what product, web page, or other interface was used for the query. Context information can distinguish a type of user (e.g., developer or data analyst) or other distinctions that may suggest different target content. User telemetry through the marketplace is also recorded to ensure that the data searched for is indeed absent from the marketplace, not simply categorized in a way the user did not expect. The system may classify terms using a dictionary and web services for related searches. The system also presents the user with a user interface to capture more information about what the user wanted, such as a desired dataset, a scenario the user wants to enable and optionally, other datasets and categories of data and applications the user would like to see (e.g., the user is able to provide name of company or specific offering from the company).

The data fulfillment system uses a web service and/or the current backlog to provide the user a list of offerings that are currently being worked on or that are available through other content providers. The user can choose whether one of these offerings would provide the information for which the user is searching. This data is periodically compared with the supply database to create leads for business development teams, assisting with prioritizing partnerships in play as well as providing opportunities the teams can go after with likelihood of closing the deal based on data from both the supply database (as historical data of what kinds of companies they have closed, in what regions, with what price points) and demand database.

In some embodiments, partners receive data from the supply and demand databases in an effort to ensure the marketplace has a balanced economy of content. This enables partners to improve their offerings or to think about exposing new offerings in the marketplace.

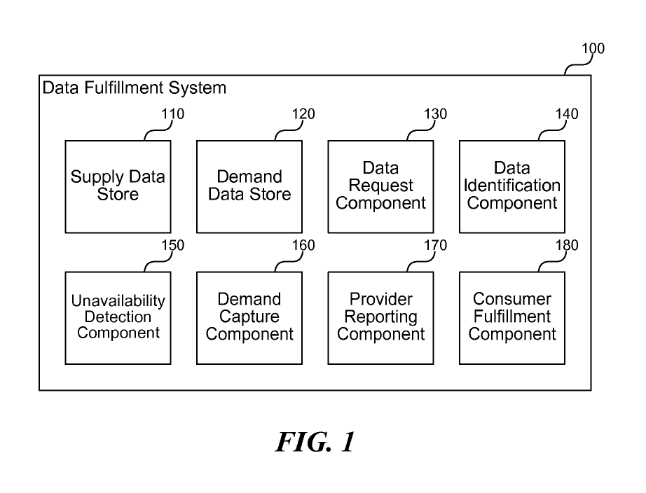

FIG. 1 is a block diagram that illustrates components of the data fulfillment system, in one embodiment. The system 100 includes a supply data store 110, a demand data store 120, a data request component 130, a data identification component 140, an unavailability detection component 150, a demand capture component 160, a provider reporting component 170, and a consumer fulfillment component 180. Each of these components is described in further detail herein.

The supply data store 110 stores information describing one or more data offerings available to a data consumer and offered by a data provider in a data marketplace. The supply data store 110 may include one or more files, file systems, hard drives, databases, storage area networks, cloud-based storage services, or other facilities for persisting and providing access to data. In some embodiments, the system 100 provides a cloud-based data marketplace built on a web services platform like MICROSOFT™ AZURE™. The supply data store 110 may include information related to each data offering such as a description of the data that is available, sample data, fee/subscription information for obtaining the data, a format of the data, and so forth. Providers add new data offerings to the supply data store 110 to make them available to consumers and consumers browse and search the supply data store 110 to find data and applications to accomplish particular tasks.

The demand data store 120 stores information describing one or more failed attempts to access data from the supply data store 110, wherein the failure indicates that the data was not available or not available in a form requested by a consumer. In some embodiments, the system partners with an affiliate to track and store demand data in a brokered model. The demand data store 120 tracks what consumers wish was available in terms of applications and datasets from the supply data store 110 and provides a quantifiable record of demand for new data that can be reported to providers to enable the providers to fill gaps in the types of data available and to promote a healthier marketplace.

The data request component 130 receives a query from a data consumer to identify one or more matching data offerings in the supply data store. The query may include a text query string specifying one or more keywords against which to match the available data offerings. The component 130 may provide a user interface in the form of a web page, mobile application, desktop application, or programmatic application-programming interface (API) through which consumers submit requests. The data request component 130 may capture additional information in the query, such as a category in which to search, particular providers that the consumer prefers, and so forth. In some cases, the system may store user profile information related to consumers and providers that provides additional information that the data request component 130 can use to process a query.

The data identification component 140 identifies data offerings that match the received query and reports any matching data offerings to the consumer. For example, the system 100 may store an index of available data offerings and applications for consuming the datasets and may use the index to look up keywords in the query to identify matching data offerings. The component 140 can match data offerings based on words in a data offering description, provider information, or any other information associated with a particular data offering. The consumer may indicate whether any particular offering satisfies the consumer's request by purchasing the offering or by making another indication (e.g., checking a checkbox next to the offering) to shows the consumer's interest in the offering.

The unavailability detection component 150 detects a query that either returns no available data offerings or for which the consumer indicates that no returned data offering satisfies one or more criteria of the consumer. The component 150 may detect searches with zero results or may survey the consumer after each search to inquire whether the consumer found the data for which the consumer was searching. The component 150 can also use other techniques for identifying user frustration or dissatisfaction such as repeated queries with slight modifications, flipping back and forth between pages of results, and so forth. Upon detecting these conditions, the component 150 may display a dialog box or other user interface to the consumer to inquire whether the consumer is having difficulty finding a matching data offering.

The demand capture component 160 records information describing a detected failed query in the demand data store. Over time, as many consumers query the supply data store and some percentage fail to identify matching data offerings, the demand data store 120 builds up a useful quantity of information related to consumer demand. This information can be aggregated and sorted to bring the most in demand data offerings to the fore. In some cases, the system 100 applies human expert or automated analysis to identify data queries that identify the same unavailable data even though consumers may use differing query terms or provide a different description of the data for which the consumer was searching. The demand capture component 160 aggregates this information and tracks the information for reporting to providers in the demand data store 120.

The provider reporting component 170 provides a user interface through which potential data providers can access the demand data store to identify one or more data offering opportunities based on prior consumer data requests. The provider reporting component 170 may provide a web page, mobile application, desktop application, or programmatic interface through which providers or analysis applications used by providers can access the demand database to identify the data offering opportunities. The interface may provide sorting and filtering options so that, for example, a provider can look for data offerings in a particular category with which the provider is familiar and for which there is sufficient demand to justify effort to generate a new data offering. In response, the data provider may go out and create or acquire the requested data from other sources and offer the data in the marketplace. This makes the marketplace offerings more complete and provides a ready incentive to fill any gaps in available data and to provide data in the format most requested by consumers.

The consumer fulfillment component 180 optionally notifies a consumer that previously failed to find a matching data offering upon availability of a new data offering that is responsive to the consumer's prior query. Based on user profile information or information captured at the time of the failed request, the system 100 may have stored contact information for the consumer, such as an email address, with which the system 100 can notify the consumer. The system 100 may also provide notifications via push notifications provided by a device platform, text messages, or other notification methods used in the art. This helps encourage consumers to return to the data marketplace and to recognize that the system operator is working to ensure that consumers find the data that they seek.

The computing device on which the data fulfillment system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

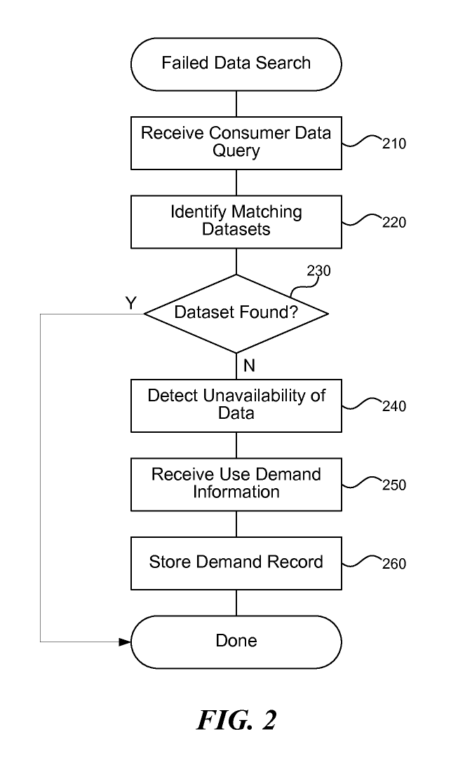

FIG. 2 is a flow diagram that illustrates processing of the data fulfillment system to handle consumer data queries, in which at least one query results in no matching data, in one embodiment. Beginning in block 210, the system receives a consumer data query requesting one or more matching datasets from a data marketplace containing data offerings from data providers. The data offerings may include a wide variety of data types and content, including text, tabular, audiovisual, or other types of data related to a wide variety of topics, from gas prices to stock information to corporate employees to government information. The query may include one or more keywords or other types of query information and may also include filtering information including one or more data categories in which the consumer expects to find matching datasets.

Continuing in block 220, the system performs a search to identify one or more matching datasets. The search may consult an index or other data structure for efficiently matching the consumer's data query against potentially many data offerings stored in a data store. The system identifies matching datasets based on a dataset description, information submitted by a provider of the dataset, embedded content within the dataset, or through other matching facility. For most queries, the system may identify one or more matching datasets, but for a small percentage of queries or category of queries, the system may find no matching datasets available.

Continuing in decision block 230, if the system determines that no matching dataset was found that satisfies the received data query, then the system continues at block 240, else the system provides a set of search results to the consumer from which to select an available dataset and then concludes the search. Even upon finding available datasets, it is possible that the datasets do not satisfy the consumer for one reason or another. In such cases, the system may detect this condition (e.g., by asking the consumer) and continue with the following steps to report the unavailability of matching data.

Continuing in block 240, the system detects the unavailability of a dataset matching the received data query. As noted above, this may occur because no datasets were returned by the search or because the consumer indicates dissatisfaction with the available datasets returned. The system captures this information and tracks unavailability of data in a demand data store as detailed herein.

Continuing in block 250, the system receives user demand information that describes a dataset that the consumer was unable to find in the data marketplace. The system may display a form or other user interface for the consumer to fill out upon detecting unavailability of particular data. The form includes fields that request particular information from the consumer detailing what the consumer wanted. This information may include a text description, categories, sample data like what the consumer wants, a known alternative source of the data, and so forth.

Continuing in block 260, the system stores a demand record in a demand data store that persists the received user demand information for later analysis. The demand record may include information related to the user, such as contact information or identification of a user profile record, the demand information provided by the consumer, categorization information of the demand record, historical/statistical information quantifying related requests, and so forth. In some cases, the system may display to the consumer other received demand information and ask the user whether the other demand information matches data for which the user is searching. After block 260, these steps conclude.

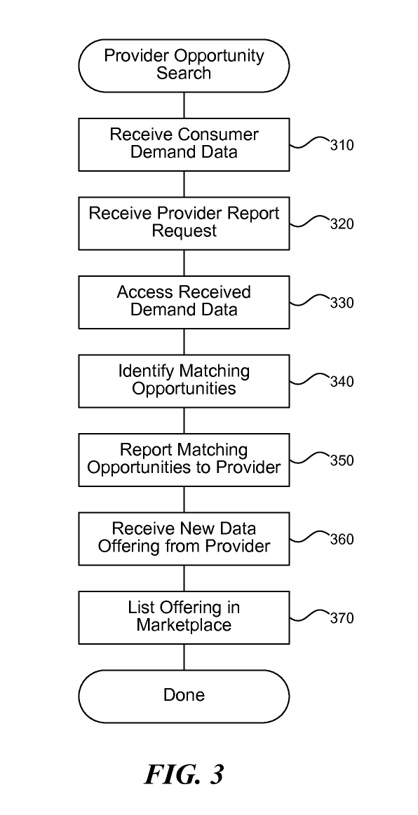

FIG. 3 is a flow diagram that illustrates processing of the data fulfillment system to provide information regarding data fulfillment opportunities to a data provider using a data marketplace, in one embodiment. Beginning in block 310, the system receives consumer demand data from one or more consumers unsuccessfully searching for data from a data marketplace. The received demand data may include a description of information wanted by the consumers, categories associated with the information, a quantity of consumers looking for the information, a frequency with which the data is requested, and so forth.

Continuing in block 320, the system receives a provider report request that requests information describing one or more opportunities for offering data responsive to unsuccessful consumer data requests. The provider request may identify one or more categories with which to filter demand data and other provider criteria, such as a size of the opportunity based on a threshold number of requesting consumers, and so forth. The system may receive the request through a user interface provided by the system that providers access or log into to search for available opportunities. In some embodiments, the system may sell access to opportunity information and check for a provider subscription or other payment verification before providing access to demand data.

Continuing in block 330, the system accesses received demand data from a demand data store that stores the received consumer demand data. Provider reporting and demand storage functions of the system may occur in the same place or may be separated. For example, demand requests may be directed to a particular administrative access server while demand data may be stored in a cloud-based database that receives incoming consumer requests. Thus, the system may access local or remote demand data in response to the received provider request.

Continuing in block 340, the system identifies one or more opportunities indicated by the demand data that are responsive to the received provider report request. The system may apply a threshold to eliminate consumer demand that is insufficient to report and may filter by categories or other received provider criteria in order to relay to the provider the most relevant opportunities.

Continuing in block 350, the system reports identified matching opportunities to the provider. The system may display a user interface (e.g., via a web page), send a report to the provider (e.g., via email), or provide the report in some other way. The report may include text, graphs, or other information to convey to the provider each potential opportunity as well as relevant information associated with the opportunity, such as a magnitude of consumer demand, individual consumer comments describing the requested data, and so on.

Continuing in block 360, the system optionally receives a new data offering in response from the provider. Based on real identified consumer demand the provider can focus his time on providing those types of data that are most requested and thus most profitable for the provider. Therefore, the provider can make a business of responding to identified consumer demand and providing targeted data offerings in response to the demand data.

Continuing in block 370, the system lists the received new data offering in the marketplace so that subsequent consumer requests for the same data will find the new offering available. In this way, the system fulfills previously failing consumer requests by encouraging provider interaction with the system. The system may also proactively notify consumers that previously searched for a data offering like the new offering submitted by the provider. After block 370, these steps conclude.

As described herein, the data fulfillment system provides a positive feedback loop in which consumer needs drive provider offerings. Providers receive targeted information about what consumers need, and consumers can directly provide information about what they need if they do not find satisfactory data already. In addition, the system can also track successful uses of data so that providers receive feedback about what data is already available that consumers are finding particularly useful. At sell/idea time, providers can query the system for interest and at feature revision time providers can query for needed features. Providers that are not already associated with the system may decide to join the marketplace to provide unavailable data or may decide to partner with another provider to augment available data with new information.

In some embodiments, the data fulfillment system detects data used commonly with other data. For example, the system may notice that a demographic dataset is frequently purchased with a crime dataset. The system may also notice that consumers of these datasets frequently add similar additional columns. For example, the system may observe that zip code information is commonly added to crime data. This information allows the system to provide additional information to providers in the provider reports described herein. For example, the system may suggest that two providers work together to provide a unified set of data or to add missing data that is costing consumers redundant effort. The system may also observe which datasets are purchased with which data consuming applications to make related reports to providers. The system anonymizes consumer information so that personal consumer data is not exposed to providers unless a consumer has specifically elected to do so.

In some embodiments, the data fulfillment system can proactively or reactively provide reports to providers. Reactive reports are described herein in which the provider accesses the system with a specific request to receive a report. The system may also proactively provide suggestions to providers, such as by emailing reports, notifying providers of aggregate consumer demand related to their focus area, and so forth. In some cases, the system may report to the providers an amount of data used in a dataset. For example, the system may determine that consumers commonly buy a large dataset but then only use a handful of rows. In such cases, the provider may be better served by offering a reduced set of data or by dividing the data up into separate offerings that would individually be more appealing to a broader base of consumers (perhaps those for which the large dataset is too expensive).

In some embodiments, the data fulfillment system provides for consumer voting on suggested or available data offerings. For example, the system may present two potential data offerings to a consumer in an NB style test. The system receives a vote from the consumer indicating which dataset the consumer would be most likely to purchase. The system can survey consumers at search time or via contact information provided to the marketplace. In some cases, the system may collect demographic information to determine which consumer groups prefer which data offerings.

In some embodiments, the data fulfillment system provides one or more feeds to which providers and consumers can subscribe to learn about demands and new data offerings. For example, the system may provide one or more really simple syndication (RSS) feeds that indicate when new information is available. The system may provide feeds by category or other filtering so that providers and consumers can monitor the feeds most applicable to them.

In some embodiments, the data fulfillment system provides a private marketplace to an enterprise. Although the system as described herein is often applied to a public data marketplace, the system can also scope consumer requests and provider demand reports to private data within an enterprise. In this way, information technology personnel in an organization can learn what data users in their organization would like to be able to use and can find potentially private sources for that data that is not available and cannot be made available (e.g., due to confidentiality or other reasons) in a public marketplace.

From the foregoing, it will be appreciated that specific embodiments of the data fulfillment system have been described herein for purposes of illustration, but that various modifications may be made without deviating from the spirit and scope of the invention. Accordingly, the invention is not limited except as by the appended claims.

I/We claim:

1. A computer-implemented method to handle consumer data queries, in which at least one query results in no matching data, the method comprising:
receiving a consumer data query requesting one or more matching datasets from a marketplace containing offerings from providers;
performing a search to identify one or more matching datasets;
detecting unavailability of a dataset matching the received data query;
receiving user demand information that describes a dataset that the consumer was unable to find in the data marketplace; and
storing a demand record in a demand data store that persists the received user demand information for later analysis,
wherein the preceding steps are performed by at least one processor.

2. The method of claim 1 wherein receiving the consumer data query comprises receiving one or more keywords describing data, applications, application programming interfaces, or visualizations the consumer is seeking.

3. The method of claim 1 wherein receiving the consumer data query comprises receiving filtering information including one or more data categories in which the consumer seeks matching datasets.

4. The method of claim 1 wherein performing the search comprises consulting an index for efficiently matching the consumer's data query against potentially many offerings stored in a data store.

5. The method of claim 1 wherein performing the search comprises identifying matching datasets based on a dataset description submitted by a provider of the dataset.

6. The method of claim 1 wherein detecting unavailability comprises determining that no datasets were returned by the search.

7. The method of claim 1 wherein detecting unavailability comprises determining that one or more datasets returned by the search did not satisfy the consumer.

8. The method of claim 1 wherein receiving demand information comprises displaying a user interface for the consumer to fill out upon detecting unavailability of particular data.

9. The method of claim 1 wherein receiving demand information comprises receiving a text description from the consumer describing a type of data that the consumer was trying to find.

10. The method of claim 1 wherein storing the demand record comprises storing information identifying the consumer.

11. The method of claim 1 wherein storing the demand record comprises storing statistical information quantifying related requests.

12. The method of claim 1 further comprising displaying to the consumer other received demand information and asking the user whether the other demand information matches data for which the user is searching.

13. A computer system for filling data marketplace service requests, the system comprising:
a processor and memory configured to execute software instructions embodied within the following components;
a supply data store that stores information describing one or more data offerings available to a data consumer and offered by a data provider in a data marketplace;
a demand data store that stores information describing one or more failed attempts to access data from the supply data store, wherein the failure indicates that the data was not available or not available in a form requested by a consumer;
a data request component that receives a query from a data consumer to identify one or more matching data offerings in the supply data store;
a data identification component that identifies data offerings that match the received query and reports any matching data offerings to the consumer;
an unavailability detection component that detects a query that either returns no available data offerings or for which the consumer indicates that no returned data offering satisfies one or more criteria of the consumer;
a demand capture component that records information describing a detected failed query in the demand data store; and
a provider reporting component that provides a user interface through which potential data providers can access the demand data store to identify one or more data offering opportunities based on prior consumer data requests.

14. The system of claim 13 wherein the demand data store provides a quantifiable record of demand for new data that can be reported to providers to enable the providers to fill gaps in types of data available.

15. The system of claim 13 wherein the unavailability detection component surveys the consumer after each search to inquire whether the consumer found the data for which the consumer was searching.

16. The system of claim 13 wherein the unavailability detection component detects potential user frustration based on a consumer's actions viewing results from a search that may indicate that the consumer is having difficulty finding a matching data offering.

17. The system of claim 13 wherein the demand capture component aggregates and sorts captured demand data to identify in demand data offerings.

18. The system of claim 13 wherein the demand capture component applies automated analysis to identify data queries that identify the same unavailable data even though consumers may use differing query terms or provide a different description of the data for which the consumer was searching.

19. The system of claim 13 further comprising a consumer fulfillment component that notifies a consumer that previously failed to find a matching data offering upon availability of a new data offering that is responsive to the consumer's prior query.

20. A computer-readable storage medium comprising instructions for controlling a computer system to provide information regarding data fulfillment opportunities to a data provider using a data marketplace, wherein the instructions, upon execution, cause a processor to perform actions comprising:
receiving consumer demand data from one or more consumers unsuccessfully searching for data from a data marketplace;
receiving a provider report request that requests information describing one or more opportunities for offering data responsive to unsuccessful consumer data requests;
accessing received demand data from a demand data store that stores the received consumer demand data;
identifying one or more opportunities indicated by the demand data that are responsive to the received provider report request; and
reporting identified matching opportunities to the provider.
